(19) United States
(12) Patent Application Publication
(10) Pub. No.: US 2015/0112825 A1
(43) Pub. Date: Apr. 23, 2015

(54) CHECKOUT TERMINAL

(71) Applicant: TOSHIBA TEC KABUSHIKI KAISHA, Tokyo (JP)

(72) Inventors: Shota KONISHI, Ota Tokyo (JP); Maki SATO, Yokohama Kanagawa (JP)

(21) Appl. No.: 14/518,721

(22) Filed: Oct. 20, 2014

(30) Foreign Application Priority Data
Oct. 23, 2013 (JP) 2013-220631
Jan. 22, 2014 (JP) 2014-009660

(51) Int. Cl. G07G 1/00; G06Q 20/20; G07G 1/12

(52) U.S. Cl. CPC G07G 1/0036; G07G 1/12; G07G 1/0018; G06Q 20/208
USPC 705/23; 705/16

(57) ABSTRACT

A checkout station includes a checkout terminal having a detecting unit at a front surface thereof, and first and second shopping cart parking regions on opposite lateral sides of the checkout terminal. The detecting unit is configured to detect an item to be purchased by a customer as the item is transferred from a shopping cart parked in the first shopping cart parking region to a shopping cart parked in the second shopping cart parking region.

### CROSS-REFERENCE TO RELATED APPLICATION

This application is based upon and claims the benefit of priority from Japanese Patent Application No. 2013-220631, filed Oct. 23, 2013, and Japanese Patent Application No. 2014-009660, filed Jan. 22, 2014; the entire contents of both applications are incorporated herein by reference.

### FIELD

Embodiments described herein relate generally to a checkout terminal.

### BACKGROUND

Conventionally, merchandise data is associated with a code symbol, which is attached to the merchandise and optically read during a checkout process. A customer, instead of a store clerk, may perform the checkout by bringing the merchandise to be purchased near a scanner so that the code symbol can be read by the scanner (self scanning).

In most stores, shopping baskets and shopping carts are provided. The shopping cart is highly useful for carrying merchandise from a sales floor to a checkout counter when a large amount of merchandise is purchased. One type of a checkout terminal enables a customer to carry out the self scanning when a shopping basket is placed on a shopping cart. However, the customer has to take an item to be purchased out of the shopping basket for the self scanning and return the scanned item to the basket in which the other items to be scanned are included. This practice may be inconvenient for the customer because both the scanned item and the other items to be scanned may be commingled in the basket and it takes time and labor to sort out the to be scanned items. In addition, if the customer is intending to use a checkout terminal with self-scanning, the customer may be uncertain as to the most convenient position of the shopping cart with respect to the checkout terminal.

### DESCRIPTION OF THE DRAWINGS

FIG. 1 is an exterior perspective view of a checkout terminal according to a first embodiment.

FIG. 2 is a side view of a shopping cart.

FIG. 3 is a block diagram of units of the checkout terminal.

FIG. 4 is a functional block diagram related to merchandise sales data registration processing carried out the checkout terminal.

FIG. 5 is a flowchart of the merchandise sales data registration processing.

FIG. 6 illustrates an example of images projected by an image projection unit of the checkout terminal.

FIG. 7 illustrates another example of the images projected by the image projection unit.

FIG. 8 is a front view of an operation panel of the checkout terminal.

FIG. 9 is a plan view of a checkout area including a checkout terminal according to a second embodiment.

FIG. 10 is an exterior perspective view of an information pre-input device.

FIG. 11 is a block diagram of the information pre-input device.

FIG. 12 is a flowchart of processes containing merchandise sales data registration processing carried out by the checkout terminal.

### DETAILED DESCRIPTION

Embodiments provide a checkout terminal that can save time and labor required for a checkout.

In general, according to one embodiment, a checkout station includes a checkout terminal having a detecting unit at a front surface thereof, and first and second shopping cart parking regions on opposite lateral sides of the checkout terminal. The detecting unit is configured to detect an item to be purchased by a customer as the item is transferred from a shopping cart parked in the first shopping cart parking region to a shopping cart parked in the second shopping cart parking region.

### First Embodiment

A first embodiment will be described with reference to the drawings. A checkout terminal according to the first embodiment is a checkout terminal 1 placed at a checkout point. The checkout terminal 1 according to the first embodiment is an apparatus used in, for example, supermarkets or home centers.

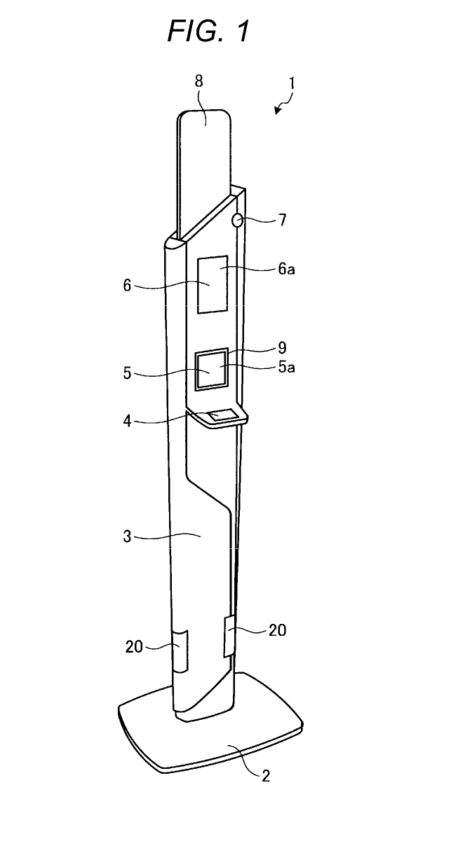

FIG. 1 is an exterior perspective view of the checkout terminal 1 according to the first embodiment. As illustrated in FIG. 1, various user interfaces are provided on a front face of a casing 3 which is erected on a pedestal 2. In other words, a card reader/writer 4, a scanner device 5, and an operation panel 6 are provided in this order from the bottom on the front face of the casing 3 erected on the pedestal 2. The card reader/writer 4 performs reading and writing of an electronic money card (not illustrated) by using a near field communication (NFC); the scanner device 5 functions as a reading unit; and the operation panel 6 functions as an operation unit which allows an operator to perform an operation required to purchase merchandise.

In addition, on the front face of the casing 3, a monitoring camera 7 as a security unit which photographs and monitors an operator for preventing crimes is located at an upper part of the casing 3, and a sign unit 8, which notifies a customer of information such as the apparatus being currently used or unused by emitting light, is located at a further upper part.

The scanner device 5 includes an image sensor (not illustrated) such as a color CCD image sensor or a color CMOS image sensor and a light source (not illustrated) such as an LED therein. In addition, the scanner device 5 includes a reading window 5a through which light is transmitted. A glass plate 9 as a transparent plate having transparency, which does not influence reading of merchandise data using the scanner device 5, is provided on the front face of the casing 3. The scanner device 5 is built in the casing 3, and is located at a position where an object outside the reading window 5a may be seen through the glass plate 9.

The scanner device 5 reads merchandise data such as a merchandise code included in a barcode, which is a code symbol attached to merchandise, or exterior information (a feature amount indicating a label of merchandise, a feature amount indicating a surface state such as a shade or unevenness circumstances of merchandise) of all or some part of the merchandise. A process of detecting code information from a code symbol such as a barcode or a two-dimensional code is a technique in the related art, and thus description thereof will be omitted here.

The operation panel 6 includes a display 6a with a touch panel function which displays various operation buttons, or merchandise data such as a merchandise name or a unit price. As the various operation buttons, there is, for example, a reading end button which informs the checkout terminal 1 of an end of reading of the merchandise data.

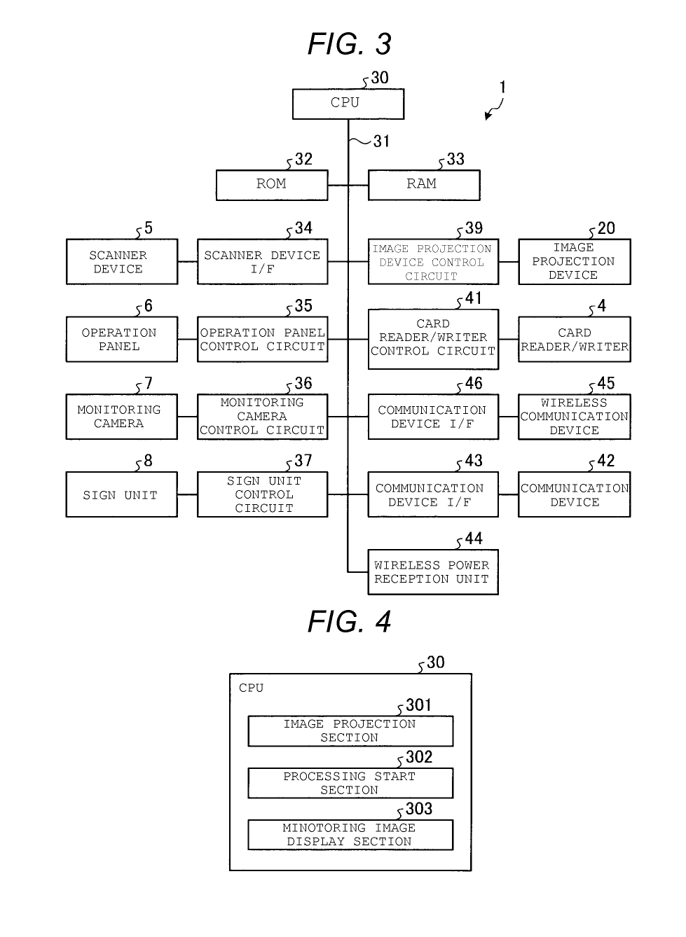

The monitoring camera 7 may photograph at least part (the face, the hand, or the like) of a body of a customer who operates the user interfaces of the checkout terminal 1. Image data captured by the monitoring camera 7 is stored in, for example, a random access memory (RAM) 33 (refer to FIG. 3), and is displayed on the operation panel 6.

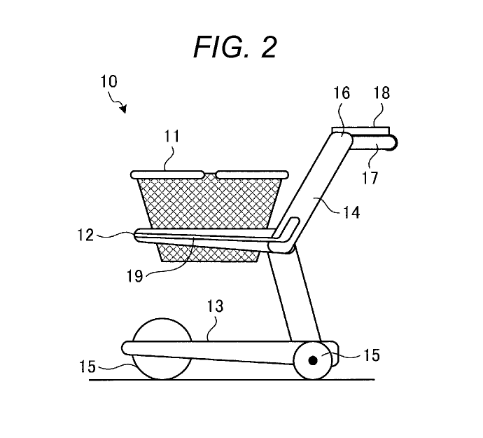

Further, image projection devices 20 are respectively provided on both sides of the casing 3 at a lower part of the casing 3 of the checkout terminal 1. Each of the image projection devices 20 includes a laser projector and a sensor (neither illustrated). The image projection device 20 irradiates a reflective plane such as a floor as a projection plane with laser light from the laser projector, and projects an image of texts, an illustration, an animation, or the like. The sensor of the image projection device 20 detects blocking of the laser light if a shopping cart 10 (refer to FIG. 2) comes into the path of the laser light.

In the checkout terminal 1 with this configuration, in a state in which the shopping cart 10 is laid alongside a lateral side of the casing 3, merchandise sales data registration processing including reading processing (self scanning) of merchandise data such as a merchandise code included in a code symbol attached to merchandise purchased by a customer or exterior information of all or some merchandise, and checkout processing, may be performed without moving a shopping basket from the shopping cart 10.

Here, the shopping cart 10 will be described briefly. FIG. 2 is a side view of the shopping cart 10. As illustrated in FIG. 2, the shopping cart 10 includes a frame 14 having cargo beds 12 and 13 on which a shopping basket 11 may be placed, respectively, and three wheels 15 provided at the lowermost part. When a customer pushes a handle 16 disposed at an upper part of the frame 14, the shopping cart 10 may be easily moved in a desired direction.

A shopping assisting terminal apparatus 18 which is a tablet terminal is provided on the handle 16 at a position where a customer may easily visually recognize and may also operate a display screen in a state of being supported at a support frame 17. The shopping assisting terminal apparatus 18 has, for example, a route navigation function of guiding a route in a store when items to be purchased are registered therein. A portable terminal such as a tablet terminal or a smart phone owned by a customer may be placed so as to replace the shopping assisting terminal apparatus 18. If a secondary battery (battery) is mounted in the shopping cart 10, the shopping assisting terminal apparatus 18 may be charged from the secondary battery (battery).

A status lamp 19 formed of a light emitting diode (LED) is provided on the entire circumference of the cargo bed 12 of the shopping cart 10. The status lamp 19 selectively turns blue or red and emits light according to a signal indicating circumstances (for example, before checkout, after checkout, and the like) in merchandise sales data registration processing of the checkout terminal 1, received by the shopping cart 10, so as to notify a customer of circumstances of the checkout terminal 1. If the status lamp 19 is provided on the entire circumference of the cargo bed 12 of the shopping cart 10, checkout circumstances and the like for a customer who currently performs merchandise sales data registration processing may be checked, and thus the status lamp 19 is not only used for security but is also used to provide information for sales promotion.

If a portable terminal such as a tablet terminal or a smart phone carried by a customer replaces the shopping assisting terminal apparatus 18, a forgetting-prevention function after the checkout is preferably provided. For example, if a signal indicating completion of the merchandise sales data registration processing is received from the checkout terminal 1, and the user's portable terminal is placed at the handle 16, a buzzer sound or the like for prompting a customer to remove the terminal may be generated.

In the shopping cart 10 with this configuration, a height of the shopping basket 11 placed on the cargo bed 12 is substantially the same as a height of the card reader/writer 4 of the checkout terminal 1 from the ground. For this reason, since the card reader/writer 4, the scanner device 5, the operation panel 6, and the like may be located at the optimum position where a customer, who is an operator, performs reading work, the customer may easily perform reading work or the like on merchandise data such as a merchandise code included in a code symbol or exterior information of all or some merchandise.

Here, FIG. 3 is a block diagram illustrating electrical connection among units of the checkout terminal 1. As illustrated in FIG. 3, the checkout terminal 1 includes a central processing unit (CPU) 30 which arithmetically processes various inputs and stored data so as to control the respective units, and the CPU 30 is connected to the respective units via a bus line 31.

The CPU 30 is connected to a read only memory (ROM) 32, which stores fixed data such as a control program in advance, and the random access memory (RAM) 33, which stores various data such as merchandise data in a freely rewritable manner. The RAM 33 is provided in plurality as necessary, and is backed up by a battery.

The CPU 30 is connected to the scanner device 5 via a scanner device interface (I/F) 34, to the operation panel 6 via an operation panel control circuit 35, to the card reader/writer 4 via a card reader/writer control circuit 41, and to the image projection device 20 via an image projection device control circuit 39. The CPU 30 is also connected to the monitoring camera 7 via a monitoring camera control circuit 36, and to the sign unit 8 via a sign unit control circuit 37. The CPU 30 is further connected to a communication device 42 via a communication device interface (I/F) 43. The communication device 42 wirelessly transmits image information from the monitoring camera 7 to a monitor or wirelessly transmits merchandise data read by the scanner device 5 to a store server (not illustrated).

The CPU 30 is further connected to a wireless communication device 45 via a communication device interface (I/F) 46. The wireless communication device 45 wirelessly transmits circumstances or the like of merchandise sales data registration processing carried out by the checkout terminal 1 to the shopping cart 10.

In addition, the checkout terminal 1 includes a wireless power reception unit 44. The wireless power reception unit 44 is connected to the CPU 30. The wireless power reception unit 44 may receive power in a wireless manner without using a power cable, for example, in a magnetic induction (MI) method or a magnetic resonance (MR) method. Consequently, if the checkout terminal 1 is disposed in a store, a power cable may not be used, and thus the preferable appearance thereof is maintained. The checkout terminal 1 may be freely laid out at a position where power may be supplied from a wireless power transmission unit (not illustrated).

Next, an operation that the CPU 30 executes in accordance with a control program stored in the ROM 32 of the checkout terminal 1 is described.

Here, merchandise sales data registration processing is carried out, which is a characteristic function of the checkout terminal 1 in an operation in which reading work (self scanning) of a code symbol attached to merchandise is performed by a customer.

FIG. 4 is a functional block diagram related to the merchandise sales data registration processing in the checkout terminal 1. As illustrated in FIG. 4, a control program executed by the CPU 30 of the checkout terminal 1 is modularly carried out by an image projection section 301, a processing start section 302, and a monitoring image display section 303. The CPU 30 reads the control program from the ROM 32 and loads the control program on the RAM 33. As a result, the image projection section 301, the processing start section 302, and the monitoring image display section 303 are generated on the RAM 33.

The image projection section 301 causes the image projection device 20 to project a predetermined image. More specifically, the image projection section 301 causes the image projection devices 20 which, are respectively provided on both side faces of the casing 3, to project different images.

The processing start section 302 starts the merchandise sales data registration processing if entry of the shopping cart 10, which is a detection object, to a region where an image is projected by the image projection section 301 is detected by the sensor of the image projection device 20.

During the merchandise sales data registration processing, the monitoring image display section 303 displays an image captured by the monitoring camera 7 on the operation panel 6, which is an operation unit included in the user interfaces.

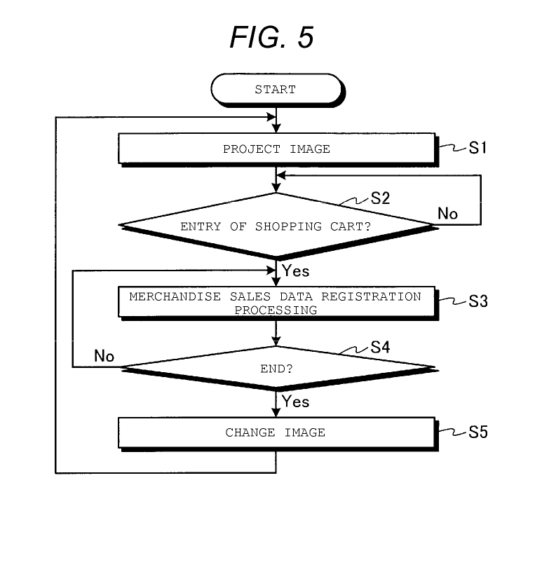

FIG. 5 is a flowchart of the merchandise sales data registration processing carried out by the checkout terminal 1.

As illustrated in FIG. 5, if power is supplied, the CPU 30 (the image projection section 301) of the checkout terminal 1 causes each image projection device 20 to irradiate the floor with laser light, so as to project an image (step S1). Hereinafter, an example of the image projected on the floor by the image projection device 20 will be described.

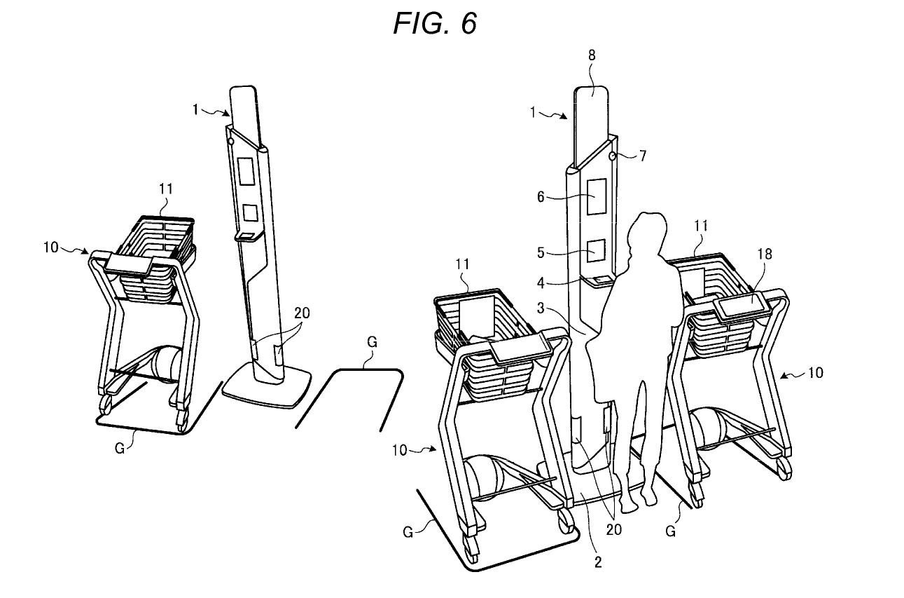

FIG. 6 illustrates an example of images projected by the image projection devices 20. In the example illustrated in FIG. 6, U-shaped guide images G are projected on both sides of the checkout terminal 1. As illustrated in FIG. 6, the orientations of the U-shaped projected guide images G on both sides are different by 180 degrees. This is because the guide images G are aimed at guiding an entry direction of the shopping cart 10 for a customer by the orientations of the U shapes. In other words, the shopping cart 10 of a customer is supposed to enter the area of the guide image G from a direction in which the U shape is open. On the other hand, the shopping cart 10 of a customer is not supposed to enter the area of the guide image G if the U shape is closed towards the customer, and the shopping cart 10 on which an empty shopping basket 11 is placed is positioned at the area.

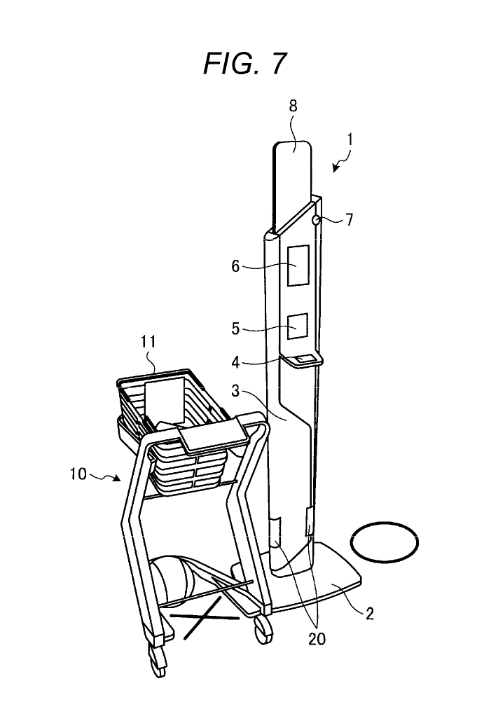

FIG. 7 illustrates another example of images projected by the image projection devices 20. In FIG. 7, X mark and O mark guide images G are respectively projected on both sides of the checkout terminal 1. As illustrated in FIG. 7, in this example, the O mark guide image G indicates that entry of the shopping cart 10 of a customer is permitted. On the other hand, the X mark guide image G indicates that entry of the shopping cart 10 of a customer is not permitted, and the shopping cart 10 on which an empty shopping basket 11 is placed is positioned thereat.

A customer lays the shopping cart 10 on which the shopping basket 11 containing merchandise is placed, alongside a lateral side of the casing 3 of the checkout terminal 1, using the guide image G as a guide. In this case, the shopping cart 10 on which the empty shopping basket 11 is placed is laid alongside the lateral side of the casing 3 that is opposite to the lateral side alongside which the customer lays the shopping cart 10.

The CPU 30 (the processing start section 302) of the checkout terminal 1 starts the merchandise sales data registration processing (step S3) if the shopping cart 10 enters a region where the guide image G is projected is detected by the sensor of the image projection device 20 (Yes in step S2).

In a state in which the customer lays the shopping cart 10 on which the shopping basket 11 is placed alongside the lateral side of the casing 3 of the checkout terminal 1 in the above-described manner, the customer performs a reading operation of taking merchandise from the shopping basket 11, causing the scanner device 5 to read merchandise data such as a merchandise code included in a code symbol attached to the merchandise or exterior information of all or some merchandise, and putting the merchandise of which merchandise data is read into a shopping basket 11 of another shopping cart 10.

If the CPU 30 of the checkout terminal 1 controls the scanner device 5 to read the merchandise data such as a merchandise code included in a code symbol attached to the merchandise or exterior information of all or some merchandise, the CPU 30 performs the merchandise sales data registration processing of acquiring merchandise information (a merchandise name, a price, and the like) based on the read merchandise data of the merchandise from a merchandise master (not illustrated) and storing the merchandise information in the RAM 33, and also displaying the merchandise information (the merchandise name, the price, and the like), a total price, and the like on the operation panel 6.

During the merchandise sales data registration processing, the CPU 30 (the image projection section 301) of the checkout terminal 1 controls the image projection device 20 to change a color of the guide image G according to reading of the merchandise data performed by the scanner device 5, thereby notifying the customer of reading circumstances of the merchandise data.

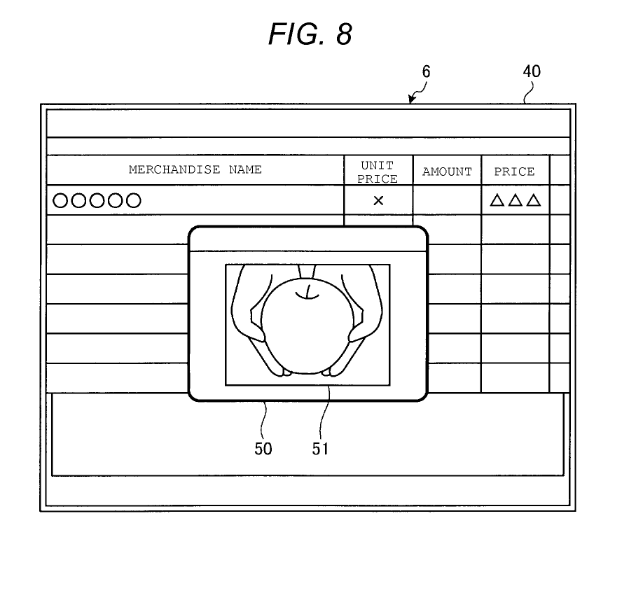

The CPU 30 (the monitoring image display section 303) of the checkout terminal 1 displays image data captured by the monitoring camera 7 on the operation panel 6 as illustrated in FIG. 8 during reading of the merchandise data in the merchandise sales data registration processing. As illustrated in FIG. 8, on the operation panel 6, a monitoring screen 50 having a display region 51 of the image captured by the monitoring camera 7 is superimposed on a registration screen 40 during the merchandise sales data registration processing and is displayed in a pop-up form.

Consequently, at least a part (the face, the hand, or the like) of the body of the customer who operates the checkout terminal 1 is displayed on the operation panel 6, and the customer performs merchandise registration including the merchandise data reading work while viewing the displayed image. Therefore, the customer may have a sense of being monitored growing, and thus an effect of minimizing a dishonest act may be achieved.

If the customer repeatedly performs the reading operation for each item of merchandise, and completes reading of merchandise data of all merchandise using the scanner device 5, the customer presses a reading end button (not illustrated) of the operation panel 6. Consequently, the checkout terminal 1 finishes the reading work.

If the reading end button (not illustrated) of the operation panel 6 is pressed, the CPU 30 of the checkout terminal 1 displays a total price on the operation panel 6, and displays a screen for prompting the customer to perform checkout processing using an electronic payment (e.g., electronic money). The customer holds an electronic money card over the card reader/writer 4 according to the display of the operation panel 6.

If the electronic money card is held over the card reader/writer 4, the CPU 30 of the checkout terminal 1 performs checkout processing by receiving electronic money in accordance with the total amount of money displayed on the operation panel 6 from the card reader/writer 4, and finishes the merchandise sales data registration processing.

After the merchandise sales data registration processing is finished (Yes in step S4), the CPU 30 (the image projection section 301) of the checkout terminal 1 changes the image projected on the side alongside which the shopping basket 11 on the shopping cart 10 becomes empty as a result of the finish of the merchandise sales data registration processing, to an image indicating non-permission of entry of the shopping cart 10, and changes the image projected on the other side to an image indicating permission of entry of the shopping cart 10 (step S5).

As mentioned above, according to the checkout terminal 1 of the first embodiment, a customer lays the shopping cart 10 on which the shopping basket 11 containing merchandise is placed alongside the lateral side of the casing 3 of the checkout terminal 1. The customer performs scanning (registration) while transferring the merchandise to the shopping basket 11 on another shopping cart 10 laid alongside the lateral side of the casing 3 opposite to the lateral side alongside which the shopping cart 10 is laid. If registration of all merchandise is completed, checkout is performed by using electronic payment, and the merchandise may be carried to a car parked at a parking lot with the shopping cart 10 to which the merchandise is transferred.

Since the shopping cart 10 brought to the lateral side of the casing 3 of the checkout terminal 1 by the customer remains there without the merchandise, a subsequent customer can perform scanning (registration) while transferring merchandise to the shopping basket 11 on the remaining shopping cart 10.

Consequently, according to the checkout terminal 1 of the first embodiment, time required for bagging and labor in moving the shopping basket 11 filled with merchandise may be saved.

As mentioned above, according to the checkout terminal 1 of the first embodiment, when the image projection devices 20 irradiate a floor where a predetermined object (the shopping cart 10) is positioned with laser light so as to project a predetermined image G, and entry of the shopping cart 10 to the region where the image G is projected is detected by the sensor, the merchandise sales data registration processing is started. Consequently, a customer can clearly recognize that the shopping cart 10 should be alongside the checkout terminal 1, and the customer may easily perform the merchandise sales data registration processing.

According to the checkout terminal 1 of the first embodiment, at least a part (the face, the hand, or the like) of a body of a customer who operates the checkout terminal 1 is displayed on the operation panel 6, and the customer performs merchandise registration including merchandise data reading work while viewing the displayed image. Therefore, the customer may have a sense of being monitored, and thus an effect of minimizing a dishonest act may be achieved.

Meanwhile, according to the control program, the CPU 30 (a weight reception section and an error notification section) of the checkout terminal 1 compares a weight difference (decrease) of the shopping cart 10 after the merchandise sales data registration processing with a weight difference (increase) of another shopping cart 10 after the processing. If the weight differences are different from each other, a notification of an error may be performed by using a buzzer sound or display on the operation panel 6. Thus, a dishonest act by a customer may be prevented.

For example, weight sensors (not illustrated) may be disposed in the two regions where the guide images G are projected from the checkout terminal 1, and the CPU 30 of the checkout terminal 1 may measure and compare weights before and after merchandise is transferred according to signals transmitted from the weight sensors. In addition, weight sensors (not illustrated) may be disposed at the cargo beds 12 and 13 of each shopping cart 10 on which the shopping basket 11 may be placed, and the CPU 30 of the checkout terminal 1 may measure and compare weights before and after merchandise is transferred according to signals transmitted from the weight sensors.

The control program executed by the checkout terminal 1 of the present embodiment may be recorded on a computer readable recording medium such as a CD-ROM, a flexible disc (FD), a CD-R, or a digital versatile disk (DVD), and be provided in a file with an installable format or an executable format.

In addition, the control program executed by the checkout terminal 1 of the present embodiment may be stored on a computer connected to a network such as the Internet, and may be downloaded via the network, so as to be provided. Further, the control program executed in the checkout terminal 1 of the present embodiment may be provided or distributed via a network such as the Internet.

The control program executed by the checkout terminal 1 of the present embodiment is modularly carried out by the above-described sections (the image projection section 301, the processing start section 302, and the monitoring image display section 303). The CPU (processor) reads the control program from the storage medium and loads the control program on a main storage device. Thus, the image projection section 301, the processing start section 302, and the monitoring image display section 303 are generated on the main storage device.

### Second Embodiment

A second embodiment will be described. In addition, the same parts as in the above-described first embodiment are given the same reference numerals and description thereof will be omitted.

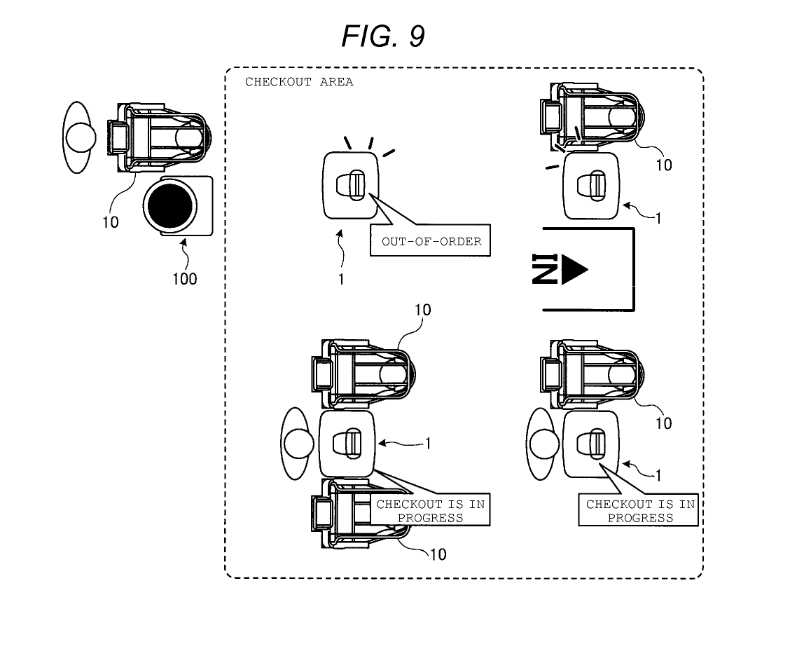

FIG. 9 is a plan view of a checkout area including a checkout terminal 1 according to the second embodiment. As illustrated in FIG. 9, the checkout area of the present embodiment includes an information pre-input apparatus (auxiliary terminal) 100 in addition to the checkout terminal 1 described in the first embodiment.

The information pre-input apparatus 100 is a device which performs membership authentication obtained through input of identification information for identifying a customer, refilling of electronic money, or the like, while the customer waits for a previous customer completing the checkout in any of the checkout terminals 1 and before merchandise sales data registration processing is performed in the checkout terminal 1. Since the information pre-input apparatus 100 is provided as mentioned above, registration awaiting time may be effectively used, and thus checkout time may be reduced.

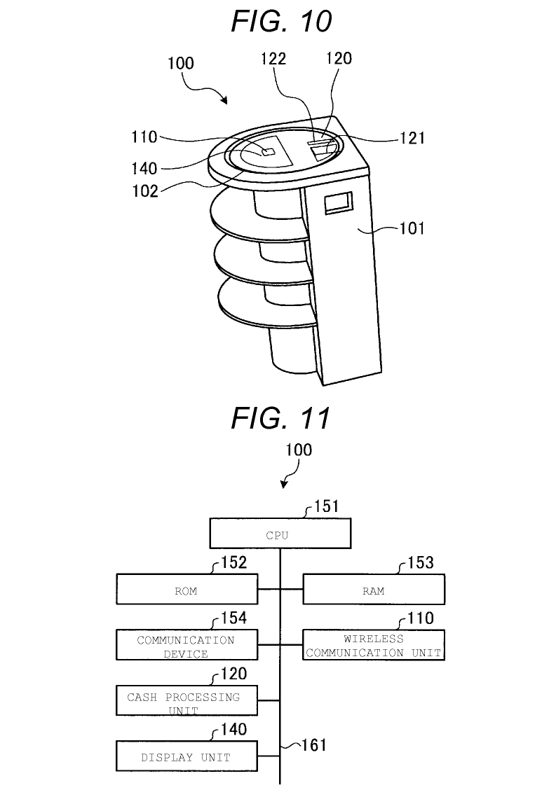

FIG. 10 is an exterior perspective view of the information pre-input apparatus 100. As illustrated in FIG. 10, the information pre-input apparatus 100 includes a wireless communication unit 110, a cash processing unit 120, and a display unit 140. Also, the information pre-input apparatus 100 includes an operation unit 102 on an upper surface of a box-shaped casing 101. Further, the operation unit 102 includes the display unit 140, and a coin insert port 121 and a bill insert port 122 of the cash processing unit 120.

The wireless communication unit 110 is provided inside the casing 101 so as to correspond to the display unit 140. The wireless communication unit 110 performs reading and writing of various information pieces on a portable terminal (not illustrated) such as a smart phone by using near field communication (NFC). More specifically, when a customer holds the portable terminal over the wireless communication unit 110, the wireless communication unit 110 may perform refill of electronic money in the portable terminal. In addition, when the customer holds the portable terminal over the wireless communication unit 110, the wireless communication unit 110 performs transmission and reception of various information pieces (identification information stored in the portable terminal, information on a variety of declaration made in advance, and the like) with the portable terminal.

The cash processing unit 120 counts cash input from the coin insert port 121 or the bill insert port 122 disposed at the operation unit 102, and refills the portable terminal of the customer with electronic money of an amount corresponding to the amount of the inserted cash, using the wireless communication unit 110.

The display unit 140 disposed at the operation unit 102 is, for example, a liquid crystal display (LCD). The display unit 140 displays a screen for prompting the customer to hold the portable terminal over the information pre-input apparatus 100 so that information can be read out by the information pre-input apparatus 100. If the refill of the electronic money using the information pre-input apparatus 100 is performed, the display unit 140 displays a screen for prompting the customer to insert cash to the coin insert port 121 or the bill insert port 122. Further, the display unit 140 may display information such as a balance of the electronic money in the portable terminal with which the refill is currently performed.

FIG. 11 is a block diagram of the information pre-input apparatus 100. A communication device 154 of the information pre-input apparatus 100 is wirelessly connected to the communication device 42 of the checkout terminal 1 and performs transmission and reception of various information pieces therewith.

The information pre-input apparatus 100 includes a central processing unit (CPU) 151 which executes various arithmetic processes so as to control each unit. The CPU 151 is connected to a read only memory (ROM) 152 and a random access memory (RAM) 153 which store programs, via a bus 161.

The CPU 151 of the information pre-input apparatus 100 is connected to the wireless communication unit 110, the cash processing unit 120, the display unit 140, and the communication device 154 via various input and output circuits (none of which are illustrated). These units are controlled by the CPU 151.

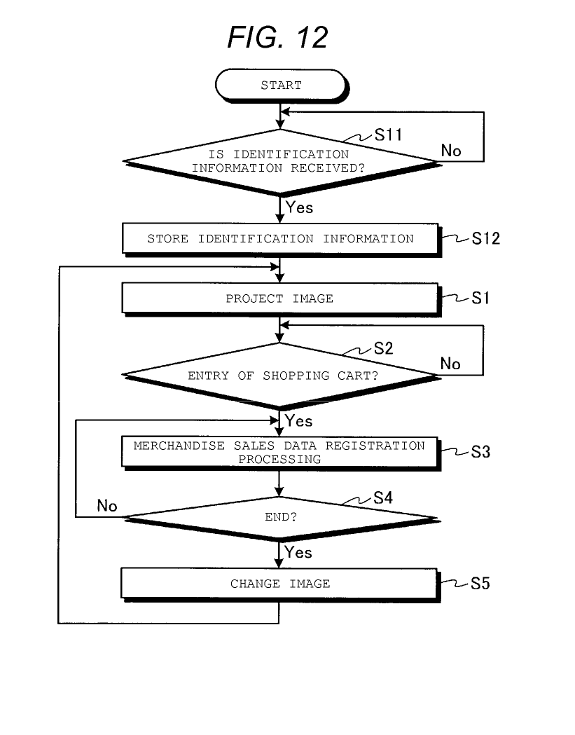

FIG. 12 is a flowchart of processes including the merchandise sales data registration processing carried out by the checkout terminal 1.

In the present embodiment, when a customer holds a portable terminal over the display unit 140 of the information pre-input apparatus 100, the CPU 151 of the information pre-input apparatus 100 receives identification information stored in the portable terminal via the wireless communication unit 110. If the identification information of the portable terminal is received, the CPU 151 of the information pre-input apparatus 100 transmits the identification information to a checkout terminal 1.

If the identification information of the portable terminal is received (Yes in step S11) from the information pre-input apparatus 100, the CPU 30 of the checkout terminal 1 stores the received identification information in the RAM 33 (step S12), activates the checkout terminal 1 by detecting the customer, and causes each image projection device 20 to irradiate the floor with laser light so that an image is projected (step S1). Therefore, the customer may be guided to the checkout terminal 1.

Next, the CPU 30 (the processing start section 302) of the checkout terminal 1 starts the merchandise sales data registration processing (step S3) if entry of the shopping cart 10 to a region where the guide image G is projected is detected by the sensor of the image projection device 20 (Yes in step S2).

A customer who performs pre-authentication in the information pre-input apparatus 100 lays the shopping cart 10 on which the shopping basket 11 containing merchandise is placed, alongside a lateral side of the casing 3 of the checkout terminal 1. The customer performs scanning (registration) while transferring the merchandise to the shopping basket 11 of another shopping cart 10 which is laid alongside an opposite side to the side alongside which the shopping cart 10 is laid. If registration of all merchandise is completed, checkout is performed by the electronic money, and the merchandise may be carried to a car parked at a parking lot with the shopping cart 10 to which the merchandise is transferred.

As mentioned above, according to the present embodiment, the information pre-input apparatus 100 performs pre-authentication and cooperates with the checkout terminal 1, and thus, for example, guiding to an available checkout terminal 1 may be performed.

In the present embodiment, the wireless communication unit 110 performs reading and writing of various information pieces on a portable terminal, which is a general smart phone or the like, using near field communication (NFC). However, the present embodiment is not limited thereto, and a terminal may performs reading and writing of various information pieces not only with the portable terminal but also with a noncontact IC card may be used. In this case, as a wireless communication unit, for example, a card reader/writer is employed which generates radio waves in a magnetic induction method and performs reading and writing of various information pieces on an IC chip of the noncontact IC card.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout station comprising:
a checkout terminal having a detecting unit at a front surface thereof; and
first and second shopping cart parking regions on opposite lateral sides of the checkout terminal,
wherein the detecting unit is configured to detect an item to be purchased by a customer as the item is transferred from a shopping cart parked in the first shopping cart parking region to a shopping cart parked in the second shopping cart parking region.

2. The checkout station according to claim 1, further comprising:
an image projecting unit disposed at the lateral side of the checkout terminal and configured to project an image on a floor with light;
a sensor configured to detect blockage of the light; and
a control unit configured to control the detecting unit to start a detection process to detect the item to be purchased, in response to the detection of the blockage.

3. The checkout station according to claim 2, wherein
the image projection unit is disposed at each of the lateral sides of the checkout terminal and configured to project different images on each of the lateral sides.

4. The checkout station according to claim 3, wherein
an image on a first lateral side of the checkout terminal is a first image indicating that a shopping cart can proceed to the first shopping cart parking region, and
an image on a second lateral side of the main body is a second image indicating that a shopping cart is not allowed to proceed to the second shopping cart parking region.

5. The checkout station according to claim 4, wherein
the control unit is further configured to determine whether or not a checkout of the item is completed, and change the image on the first lateral side to the second image and the image on the second lateral side to the first image when the checkout is determined to be completed.

6. The checkout station according to claim 2, wherein
the control unit is further configured to control the image projecting unit to change the image projected on the floor, in response to the detecting unit detecting the item to be purchased.

7. The checkout station according to claim 6, wherein
a color of the image is changed, in response to the detection of the detecting unit.

8. A checkout terminal comprising:
a main body;
a detecting unit disposed at a front side of the main body and configured to detect an item to be purchased by a customer;
an image projecting unit disposed at a lateral side of the main body and configured to project an image on a floor with light;
a sensor configured to detect blockage of the light; and
a control unit configured to control the detecting unit to start a detection process to detect the item to be purchased, in response to the detection of the blockage.

9. The checkout terminal according to claim 8, wherein
the image projection unit is disposed at each of the lateral sides of the main body and configured to project different images on each of the lateral sides.

10. The checkout terminal according to claim 9, wherein
an image on a first lateral side of the main body is a first image indicating that the shopping cart can proceed to a position adjacent to the first lateral side, and
an image on a second lateral side of the main body is a second image indicating that the shopping cart is not allowed to proceed to a position adjacent to the second lateral side.

11. The checkout terminal according to claim 10, wherein
the control unit is further configured to determine whether or not a checkout of the item is completed, and change the image on the first lateral side to the second image and the image on the second lateral side to the first image when the checkout is determined to be completed.

12. The checkout terminal according to claim 8, wherein
the control unit is further configured to control the image projecting unit to change the image projected on the floor, in response to the detecting unit detecting the item to be purchased.

13. The checkout terminal according to claim 12, wherein
a color of the image is changed, in response to the detection of the detecting unit.

14. A system for checking out an item to be purchased, comprising:
a checkout terminal including
a main body,
a first detecting unit disposed at a front side of the main body and configured to detect an item to be purchased by a customer,
an image projecting unit disposed at a lateral side of the main body and configured to project an image on a floor with light,
a sensor configured to detect blockage of the light, and
a control unit configured to control the first detecting unit to start a detection process to detect the item to be purchased, in response to the detection of the blockage; and
an auxiliary terminal located apart from the checkout terminal, including
a second detection unit configured to detect a customer at the auxiliary terminal, wherein
the control unit is further configured to control the image projecting unit to project an image next to the checkout terminal to indicate to the customer at the auxiliary terminal that the checkout terminal is available, after the second detection unit detects the customer.

15. The system according to claim 14, wherein
the system includes a plurality of the checkout terminals, and
the control unit controls the image projecting unit of one of the checkout terminals that is available to project the image indicating the available checkout terminal.

16. The system according to claim 14, wherein
the second detection unit is configured to detect the customer by receiving identification information of the customer.

17. The system according to claim 14, wherein
the image projection unit is disposed at each of the lateral sides of the main body and configured to project different images on each of the lateral sides.

18. The system according to claim 17, wherein
an image on a first lateral side of the main body is a first image indicating that the shopping cart can proceed to a position adjacent to the first lateral side, and
an image on a second lateral side of the main body is a second image indicating that the shopping cart is not allowed to proceed to a position adjacent to the second lateral side.

19. The system according to claim 18, wherein
the control unit is further configured to determine whether or not a checkout of the item is completed, and change the image on the first lateral side to the second image and the image on the second lateral side to the first image when the checkout is determined to be completed.

20. The system according to claim 14, wherein
the control unit is further configured to control the image projecting unit to change the image projected on the floor, in response to the first detecting unit detecting the item to be purchased.
